(19) United States
(12) Patent Application Publication
(10) Pub. No.: US 2014/0201839 A1
(43) Pub. Date: Jul. 17, 2014

(54) IDENTIFICATION AND ALERTING OF NETWORK DEVICES REQUIRING SPECIAL HANDLING MAINTENANCE PROCEDURES

(71) Applicant: KASEYA INTERNATIONAL LIMITED, St. Helier (JE)

(72) Inventor: Mark James Sutherland, Milpitas, CA (US)

(73) Assignee: KASEYA INTERNATIONAL LIMITED, St. Helier (JE)

(21) Appl. No.: 14/097,351

(22) Filed: Dec. 5, 2013

Related U.S. Application Data
(60) Provisional application No. 61/751,719, filed on Jan. 11, 2013.

(51) Int. Cl. H04L 29/06

(52) U.S. Cl. CPC H04L 63/145
USPC 726/24

(57) ABSTRACT

Identifying and performing maintenance operations on computer network devices may include accessing an agent portal via an administrator machine operating on a network and receiving an application user interface. The user interface may be used to request a device list of active network devices currently operating on the network and identify a number of devices that require a remote maintenance operation and at least one flagged device which requires an alternative type of remote maintenance, and perform the remote maintenance operation on at least one of the devices while omitting the flagged device at least temporarily.

### CROSS-REFERENCE TO RELATED APPLICATIONS

This application claims priority to earlier filed provisional patent application No. 61/751,719 entitled “SPECIAL HANDLING SYSTEM INSTRUCTIONS” filed on Jan. 11, 2013, the entire contents of which are hereby incorporated by reference.

### TECHNICAL FIELD OF THE APPLICATION

This application relates to providing alerts and messages to user interfaces and related application, and more particularly, to identifying which devices on a network require special handling and sensitive treatment prior to performing maintenance procedures.

### BACKGROUND OF THE APPLICATION

Conventionally, automated computer management systems are designed to perform system maintenance tasks (e.g., updates, hard disk scans, computer virus checks, etc.) on all computer systems under management the same way or in a similar manner and time. Some devices and/or systems require special handling prior to or instead of standard system maintenance. For example, when performing maintenance on high availability servers the service functions may only be performed in a limited time window, and may require a call before working on a certain device (e.g., executive's computer). It is important to make technicians and administrators aware of machines requiring special handling in a visible and clear manner to insure special steps are not overlooked.

Current techniques involve listing special operating instructions in separate databases, lists, or ‘note’ area sections in a management tool interface. This limited approach still requires the administrator to check each of the separate device, systems, etc., prior to using the management system. This created a situation where numerous errors could occur. Due to time constraints, resolving the device problems on critical systems the administrators are under pressure to act quickly to solve a problem and ensure that certain devices are not modified or changed at the wrong times. As a result, the administrators may initiate a management set of operations on devices without identifying external special instructions first.

Typical IT automation management systems list machines under management with an identification icon to select in order to access that machine or to perform tasks on that machine. Such icons may be listed on the main control page of a user interface and may provide a limited list of information that does not include cautionary information or indications of the sensitivity of that particular device.

### SUMMARY OF THE APPLICATION

One embodiment of the present application may include a method that provides accessing an agent portal via an administrator machine operating on a network, receiving an application user interface, requesting a device list of active network devices currently operating on the network, receiving the device list from memory, identifying a plurality of devices requiring a remote maintenance operation and at least one flagged device which requires an alternative type of remote maintenance, and performing the remote maintenance operation on at least one of the plurality of devices.

Another example embodiment may include an apparatus that includes a transmitter configured to access an agent portal operating on a network, a receiver configured to receive an application user interface, a processor configured to generate a request for a device list of active network devices currently operating on the network, and the receiver is configured to receive the device list from memory and the processor is configured to identify a plurality of devices requiring a remote maintenance operation and at least one flagged device which requires an alternative type of remote maintenance, and perform the remote maintenance operation on at least one of the plurality of devices.

### BRIEF DESCRIPTION OF THE DRAWINGS

FIG. 1A illustrates an example network configuration of an administrator device accessing network servers to perform system maintenance, according to example embodiments of the present application.

FIG. 1B illustrates an example logic diagram of an administrative device performing system maintenance, according to example embodiments of the present application.

FIG. 2A illustrates an example device list user interface according to example embodiments.

FIG. 2B illustrates an example device instruction and schedule user interface used to perform system maintenance according to example embodiments.

FIG. 2C illustrates an example device update and instruction creation user interface according to example embodiments.

FIG. 2D illustrates an example icon creation and assignment template user interface according to example embodiments.

FIG. 3 illustrates an example system diagram of a communication session between various network entities, according to example embodiments of the present application.

FIG. 4 illustrates a flow diagram of an example method according to an example embodiment of the present application.

FIG. 5 illustrates a system configuration that is configured to perform one or more operations corresponding to the example embodiments.

FIG. 6 illustrates an example network entity device configured to store instructions, software, and corresponding hardware for executing the same, according to example embodiments of the present application.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

According to example embodiments of the present application, an administrator may be any information technology (IT) systems administrator, IT service provider, and/or computer owner/operator who provides administrative functions to the computer devices, communication based connections and other network resources. An administrator machine may be any network-connected computer device operated by the administrator. The administrator machines may be connected directly to a server machine, or over a remote network connection to a server, managed machines and other computer networking machines.

A virtual systems administrator server and/or application may be a web-based application that permits the administrator machine, server, etc., to manage one or more remotely managed machines or client devices. A secure network channel may be setup and established between the systems administrator machine and the managed machine via the systems administrator application. The secure network channel may provide connections over which data packets may be exchanged. The network channel may pass through a wide area network (WAN) (e.g. the Internet) or through a private local area network (LAN).

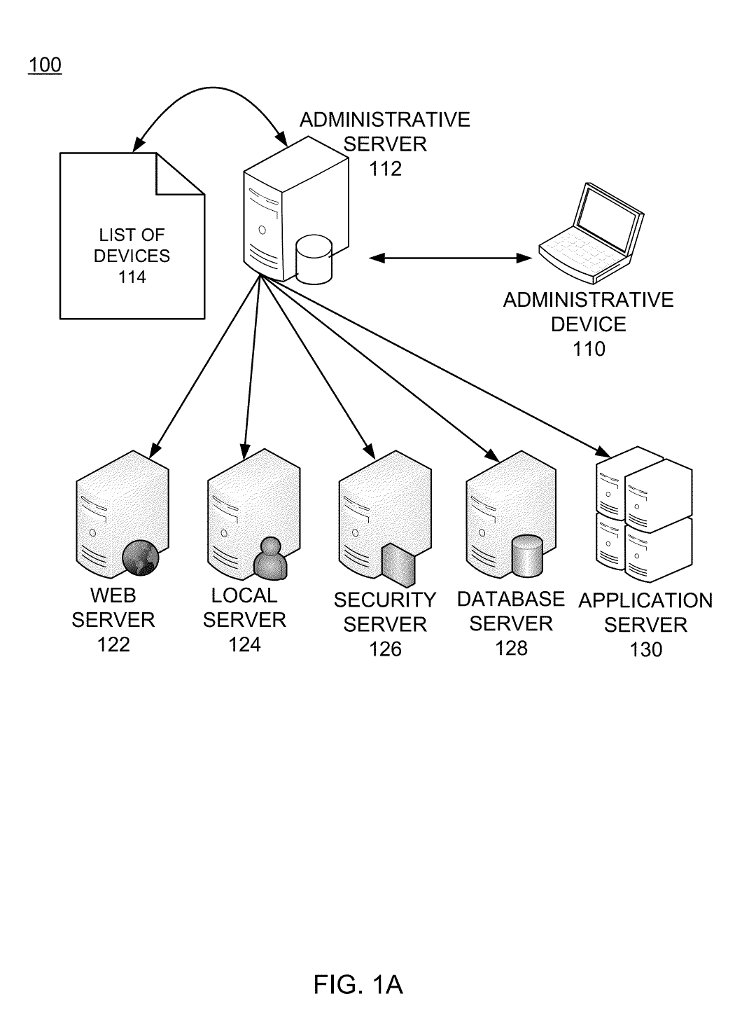

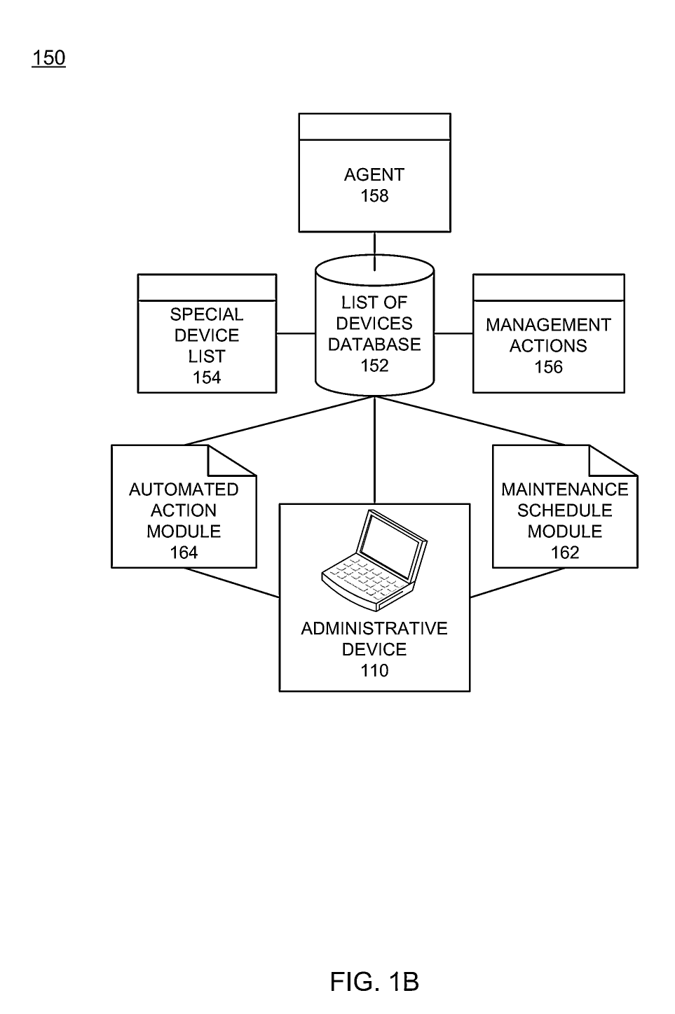

FIG. 1A illustrates an example network configuration of an administrative device performing network device management over the network according to example embodiments. Referring to FIG. 1A, the network 100 includes administrative device 110 which is in communication with an administrative server 112 and/or storage database to receive access to a preapproved list of devices on the network that require routine maintenance. The administrative server 112 may perform updates on the various servers, devices and operating system platforms. The communication may be over a WAN, such as, the Internet, or a LAN. The administrative device 110 may be a laptop, computer, personal digital assistant, tablet, smart phone or any other computer network compatible device capable of establishing a communication path or secure channel with the administrative server 112, which may also be any of the above computing devices.

In operation, the administrative device 110 may access a list of devices 114 which require maintenance and those which are flagged as special handling or sensitive devices that require sensitive treatment unlike the other devices. For example, certain servers and or devices may have limited windows of time that they can be updated, taken off-line or accessed for maintenance purposes. The list of devices 114 may identify all the devices on the network and have different categories for certain ones of the devices. In one example, the list 114 may be a data file that identifies the web server 122, local server 124, security server 126, database server 128 and application server 130 by name. Each of the devices in the list may have a corresponding flag identifier, no identifier and/or other type of designation that may be used to identify the status or limitations/requirements of that particular device with regard to system maintenance.

In one example, the data file list 114 identifies the devices operating on the network, including for example, the web server 122, local server 124, security server 126, database server 128 and application server 130. Each device may have a regular status or no status indicating that whatever system maintenance procedure that device requires may be performed without any cautionary action. However, if a particular device requires special treatment (e.g., hour restrictions, no updates during the working hours, no changes without explicit permission, etc.), then that device may invoke an instruction or pop-up window to appear on the user interface when a system maintenance operation is invoked. In this example, the application server 130 may be used continuously and may disrupt users who access online or cloud applications during working hours. As a result, the application server 130 may have a special condition that requires all maintenance or connection procedures be conducted between the hours of 12 am and 4 am only. The other devices may not have such a restriction imposed by a status flag and may be limited to maintenance procedures any time outside the 8 am to 6 pm working hour window or no restriction at all.

The system maintenance procedure (e.g., file clean-up, virus scan, software update, patch update, application uninstall, test procedure, etc.) may be setup to be executed on each network device one at a time or more than one device at a particular time. However, those devices requiring an override option prior to performing any system maintenance procedure may be immediately revoked from the initial maintenance procedure by being removed from the initial maintenance list. Once the initial procedure is invoked, an initial list of all devices on the network may be generated along with at least one particular maintenance operation to be performed to those devices. The initial list may be updated prior to execution of the maintenance operation by removing the sensitive or special treatment devices from the list by identifying those devices' respective flags and using the flags as a trigger to remove those devices from the initial list. The maintenance procedure may then be executed for the first set of devices while the special treatment devices are excluded until an alternative or secondary procedure list can be created that accommodates the requirements of those special treatment devices.

FIG. 1B illustrates an example logic diagram of an administrator device performing system maintenance, according to example embodiments of the present application. Referring to FIG. 1B, the logic diagram 150 includes a database 152 that stores the various devices and corresponding restrictions. The database may be accessed to identify a special device list 154 of devices that have restrictions imposed. A set of management actions 156 may be identified that can be used to create a maintenance procedure list that is employed by an agent application 158.

The administrative device 110 may then access an automated action module 164 to create a maintenance list of devices and times to perform the maintenance procedures. The list may be automatically modified or limited by removing certain devices that are identified by their respective flags (i.e., special treatment devices). The modified list may be set to execute via a maintenance schedule module 162. Devices that are not to be updated or modified at the time originally proposed may be set aside or may be part of a new or modified list that has different maintenance times imposed for the devices which require a separate maintenance schedule. Additionally, at some future time the devices that were previously identified as requiring special maintenance procedures may be identified again at a later time and screened or checked for any changes which may have occurred since the last identification operation. For example, the devices which may have been identified as not being capable of receiving updates 22 hours of the day due to large amounts of usage and resource sharing may then be changed later if the circumstances change or other servers are added to the group to relieve the dependency of the previously flagged server which may now be un-flagged and accepting maintenance operations without cautionary indicators or preventive measures.

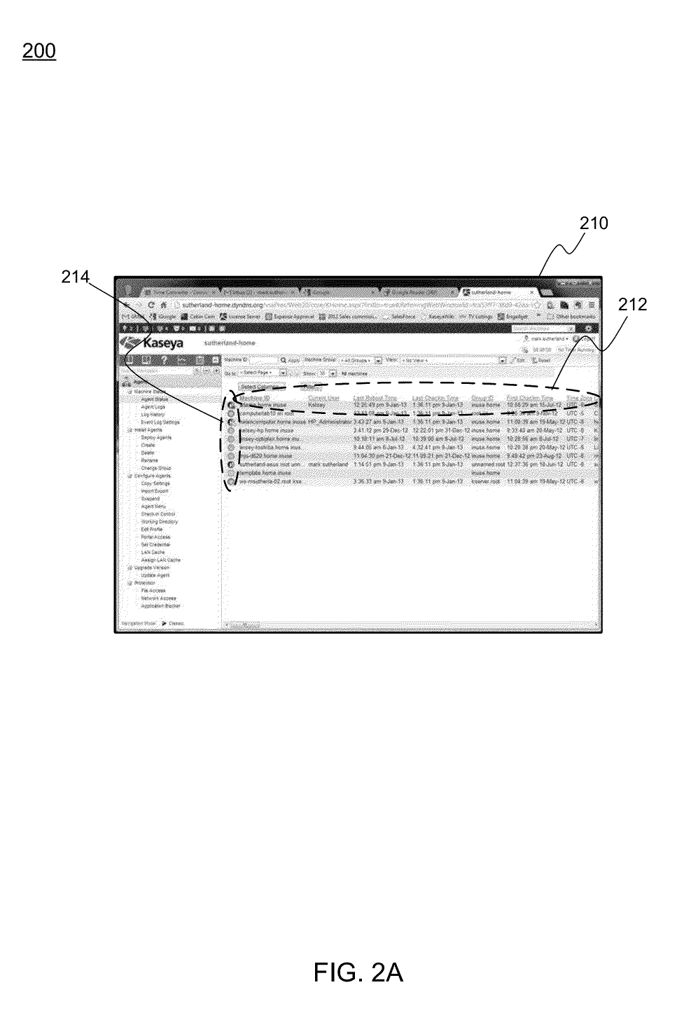

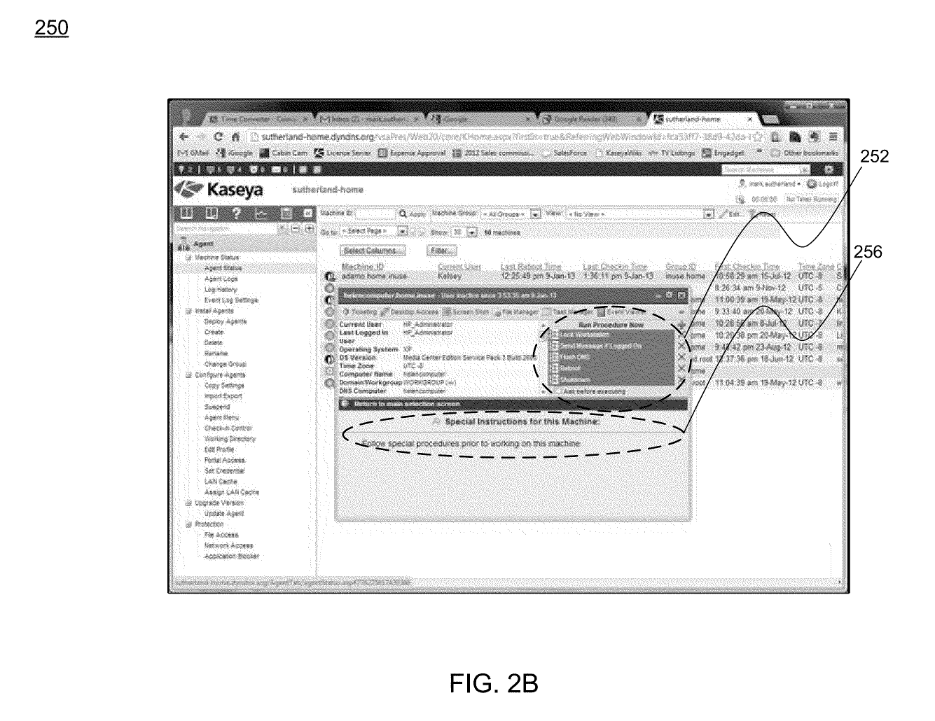

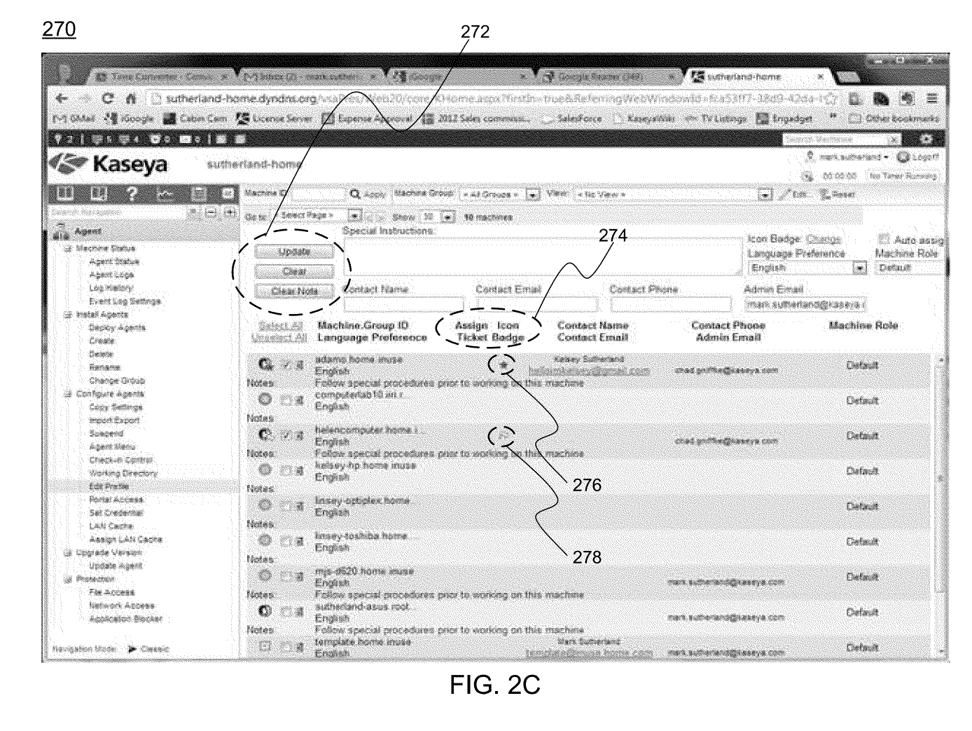

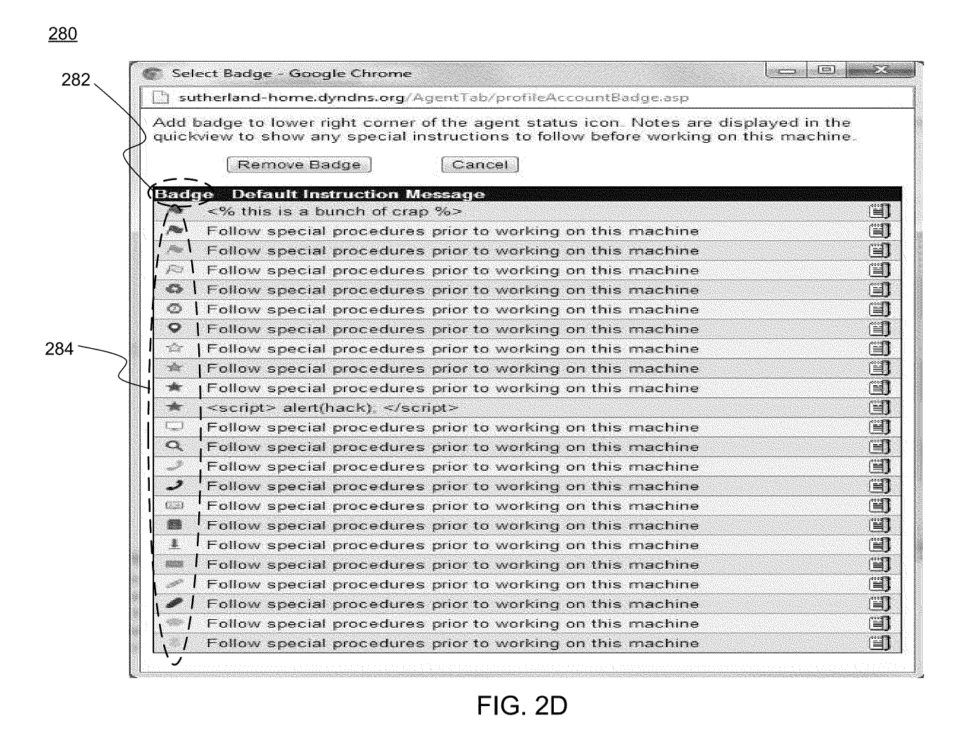

FIG. 2A illustrates an example device list user interface according to example embodiments. Referring to FIG. 2A, the user interface 200 includes a screenshot of a web portal 210 that provides the user with a view of the various computers or machines operating on the network. The machines are identified by certain headers 212 including the machine identifier (ID), the current user of the machine, the last reboot time, the last check-in time, the group ID, the first check-in time, and the time zone. This information provides a quick view of the machine maintenance schedule and any updates that may have recently occurred. The machines are also identified by a logo 214 that provides a way to identify if the machine requires special handling, has been updated recently, is overdue for an update, etc.

FIG. 2B illustrates an example device instruction and schedule user interface used to perform system maintenance according to example embodiments. Referring to FIG. 2B, the user interface 250 provides an option to run a particular procedure 252 for a certain set of user machines. Once a particular machine is selected, the machine may have a set of instructions setup via a user menu 256 to avoid unnecessary or prohibited actions being taken for that machine.

FIG. 2C illustrates an example device update and instruction creation user interface according to example embodiments. In FIG. 2C, the user interface 270 includes a set of options, such as ‘update’, ‘clear’ and ‘clear note’ 272. Those options provide the user with an opportunity to setup a special menu instruction. An icon and/or ticket badge 274 may also be used as an assignment measure to assign to the machine for easy identification of certain cautionary measures. The star 276 may indicate that a machine may require pre-authorization or an overriding option. The flag 278 may indicate that the machine will automatically be removed and associated with a specific maintenance schedule file that identifies a time range or limiting variable for when the device can be serviced.

FIG. 2D illustrates an example icon creation and assignment template user interface according to example embodiments. Referring to FIG. 2D, the user interface 280 may include a badge selection list 282 with various icons or badges 284 that can be assigned to a particular machine. Each badge may be a flag to identify a particular instruction in a corresponding data file. For example, the instruction may require the update to occur at a particular time specified in the data file or may trigger an email to be generated to a particular administrator requesting permission to perform an update. Once the flag or badge is associated with a machine, each time that machine is on a list of machines to receive maintenance, the flag may trigger various events to occur (e.g., removal from the list, email requests, alerts indications, schedule cross-referencing with a calendar entry in a schedule data file, etc.).

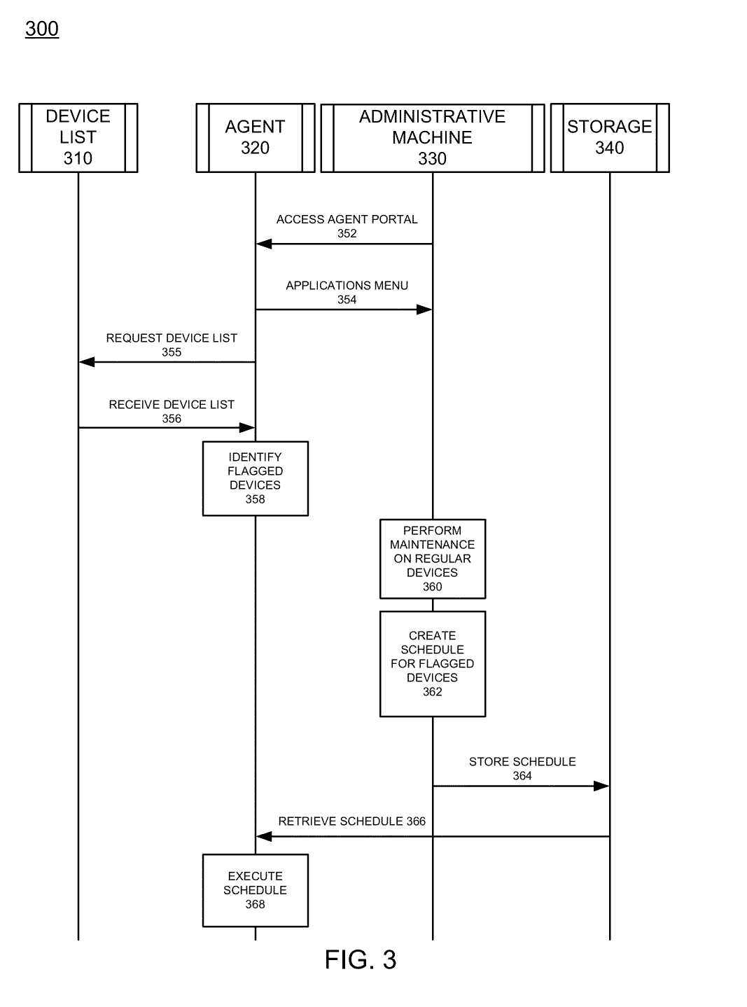

FIG. 3 illustrates an example system diagram of a communication session between various network entities, according to example embodiments of the present application. Referring to FIG. 3, the example may provide an administrative machine 330 attempting to perform a maintenance procedure via an agent application 320 of a server or installed on the administrator device. The procedure may begin by the application on the administrative machine 330 accessing the agent portal 352 and receiving options via a menu 354 for performing the various maintenance procedures. The agent 320 may then automatically request a device 355 list via a message transmitted to a database or administrative server device. The device list 310 may be a data file that is stored in memory and is retrieved and forwarded back to the agent 320. The list may have one or more flagged devices which are then identified 358 and either removed or reassigned from the original list to another list (i.e., special treatment list). The administrative machine may then execute a command to perform maintenance on the regular non-flagged devices 360 and then create a schedule for the flagged devices 362 at a later time that accommodates their specific schedule requirements. The updated schedule file may be stored 364 in memory at a storage file location and/or device 340. The regular maintenance may be performed and the schedule for the flagged devices may be performed later according to the schedule file 366 via the agent 320 executing the schedule 368.

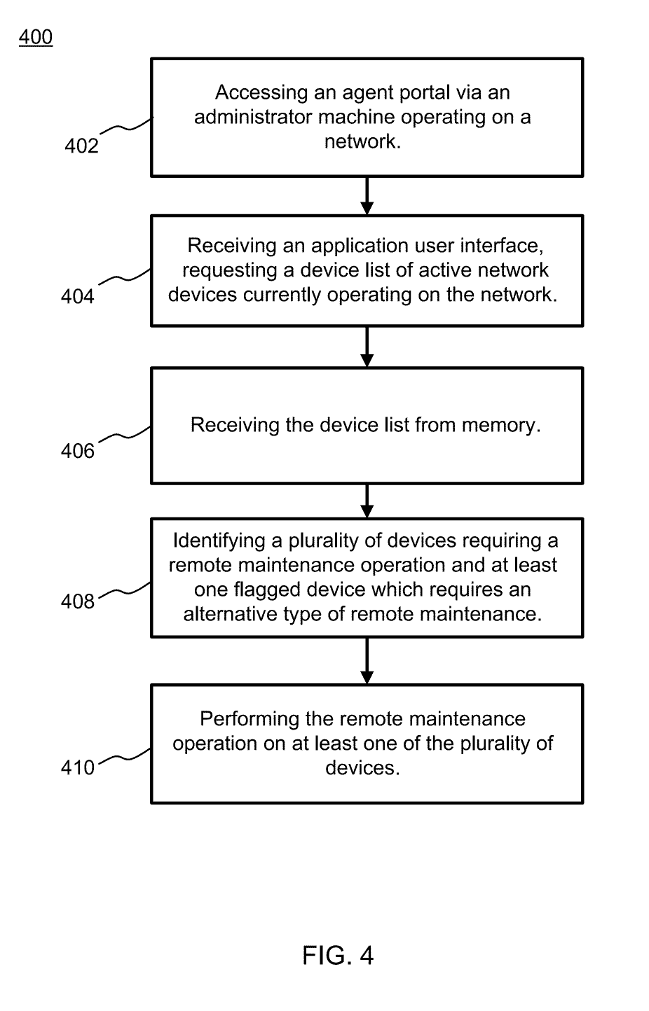

FIG. 4 illustrates a flow diagram of an example method according to an example embodiment of the present application. Referring to FIG. 4, the method may include accessing an agent portal via an administrator machine operating on a network at operation 402. The method may also include receiving an application user interface and requesting a device list of active network devices currently operating on the network at operation 404. The method may also provide receiving the device list from memory at a remote location or locally at operation 406 and identifying a plurality of devices requiring a remote maintenance operation and at least one flagged device which requires an alternative type of remote maintenance at operation 408, and Performing the remote maintenance operation on at least one of the plurality of devices at operation 410. The devices that are flagged may be associated with a flag that is a trigger for removing the device from a maintenance list or other automated data file that would normally invoke a maintenance operation.

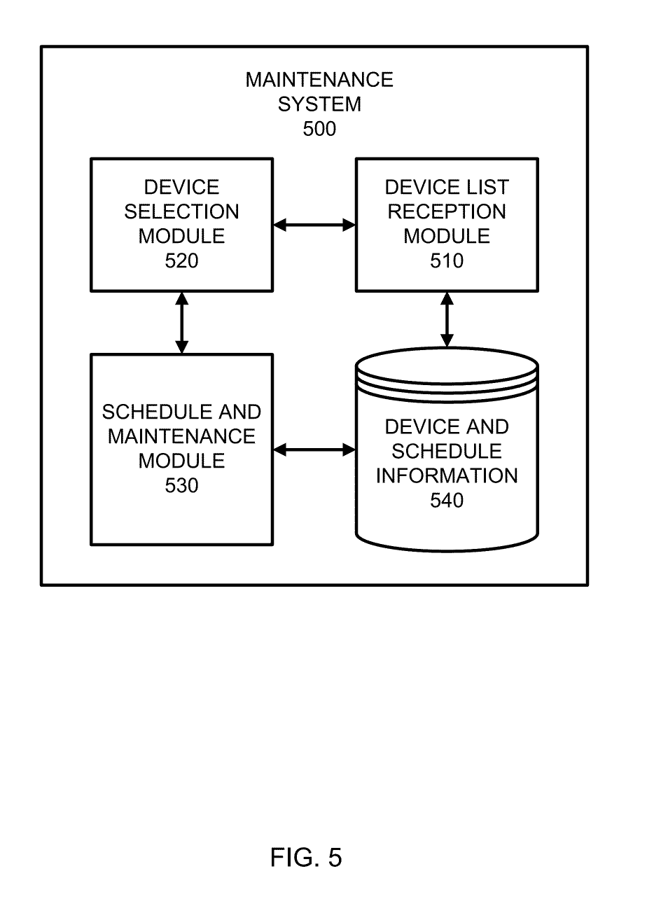

FIG. 5 illustrates an example system 500 used to perform any of the above-noted methods of operation or similar functions shared by example embodiments described herein. For example, the maintenance system 500 may include a device list reception module that performs accessing an agent portal and receiving an application user interface for requesting a device list of active network devices currently operating on the network. The device selection module 520 may identify a number of devices requiring a remote maintenance operation and certain flagged devices which require an alternative type of remote maintenance due to restrictions associated with the flag(s). The schedule and maintenance module 530 may perform the remote maintenance operation(s) on the devices that are not flagged. The maintenance may be performed by a script that automatically performs the remote maintenance operations as created by the maintenance module 530. The flagged devices can be removed from the script and placed on a different script depending on the restrictions imposed from the schedule information stored in memory 540.

Other examples may include the alternative script being created to have the remote maintenance operation originally intended, the flagged device(s) and a future time(s) to perform the remote maintenance operation(s). During the scrip and alternative script creation processed, the identification of a maintenance restriction may be performed for the flagged device(s), and the maintenance restriction may be used as the basis for the alternative script to create the future time to perform the remote maintenance operation. The remote maintenance operation includes at least one of a software application update, a hard disk scan, memory allocation, and a computer virus scan. Also, the system may check the flagged device periodically to determine whether a maintenance restriction has been removed or has expired over a predefined period of time, and if so, then the maintenance operation may be performed on the flagged device.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

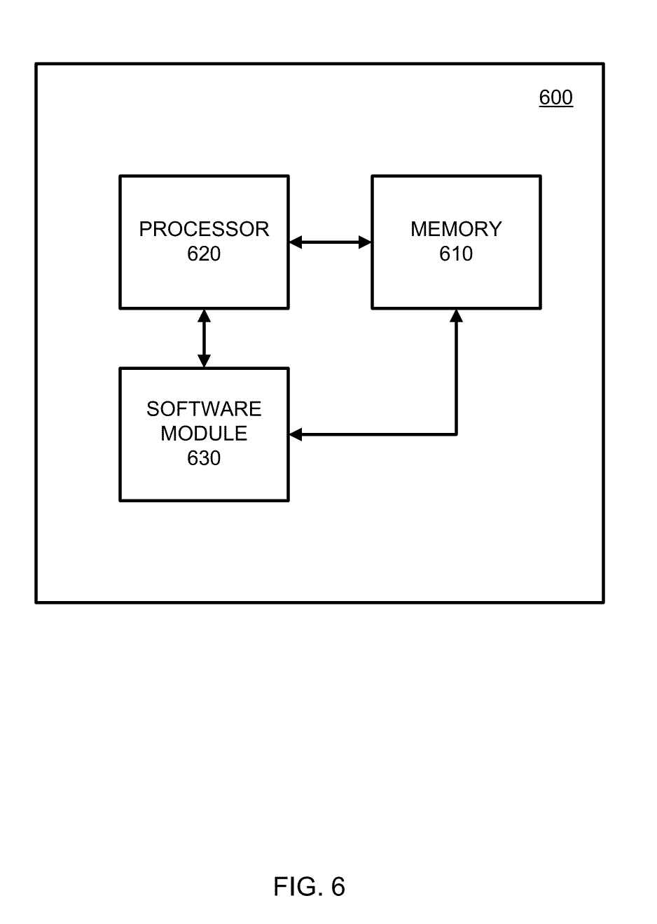

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 6 illustrates an example network element 600, which may represent any of the above-described network components, etc.

As illustrated in FIG. 6, a memory 610 and a processor 620 may be discrete components of the network entity 600 that are used to execute an application or set of operations. The application may be coded in software in a computer language understood by the processor 620, and stored in a computer readable medium, such as, the memory 610. The computer readable medium may be a non-transitory computer readable medium that includes tangible hardware components in addition to software stored in memory. Furthermore, a software module 630 may be another discrete entity that is part of the network entity 600, and which contains software instructions that may be executed by the processor 620. In addition to the above noted components of the network entity 600, the network entity 600 may also have a transmitter and receiver pair configured to receive and transmit communication signals (not shown).

Although an exemplary embodiment of the system, method, and computer readable medium of the present invention has been illustrated in the accompanied drawings and described in the foregoing detailed description, it will be understood that the invention is not limited to the embodiments disclosed, but is capable of numerous rearrangements, modifications, and substitutions without departing from the spirit or scope of the invention as set forth and defined by the following claims. For example, the capabilities of the system of FIG. 5 can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the invention, as generally described and illustrated in the figures herein, may be arranged and designed in a wide variety of different configurations. Thus, the detailed description of the embodiments is not intended to limit the scope of the invention as claimed, but is merely representative of selected embodiments of the invention.

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
accessing an agent portal via an administrator machine operating on a network;
receiving an application user interface;
requesting a device list of active network devices currently operating on the network;
receiving the device list from memory;
identifying a plurality of devices requiring a remote maintenance operation and at least one flagged device which requires an alternative type of remote maintenance; and
performing the remote maintenance operation on at least one of the plurality of devices.

2. The method of claim 1, further comprising:
creating a script that automatically performs the remote maintenance operation on the plurality of devices; and
removing the least one flagged device from the script.

3. The method of claim 2, further comprising:
creating alternative script that comprises the remote maintenance operation, the at least one flagged device and a future time to perform the remote maintenance operation.

4. The method of claim 3, further comprising:
identifying at least one maintenance restriction of the at least one flagged device; and
applying the at least one maintenance restriction to the alternative script to create the future time to perform the remote maintenance operation.

5. The method of claim 4, wherein the remote maintenance operation comprises at least one of a software application update, a hard disk scan, memory allocation, and a computer virus scan.

6. The method of claim 5, further comprising:
checking the at least one flagged device periodically to determine whether a maintenance restriction has been removed; and
if so, then performing the maintenance operation on the at least one flagged device.

7. The method of claim 6, wherein the at least one restriction is identified by a flag associated with the at least one flagged device and the removal of the restriction comprises the flag being removed.

8. An apparatus comprising:
a transmitter configured to access an agent portal operating on a network;
a receiver configured to receive an application user interface;
a processor configured to generate a request for a device list of active network devices currently operating on the network, and wherein the receiver is configured to receive the device list from memory and the processor is configured to identify a plurality of devices requiring a remote maintenance operation and at least one flagged device which requires an alternative type of remote maintenance, and perform the remote maintenance operation on at least one of the plurality of devices.

9. The apparatus of claim 8, wherein the processor is further configured to:
create a script that automatically performs the remote maintenance operation on the plurality of devices; and
remove the least one flagged device from the script.

10. The apparatus of claim 9, wherein the processor is further configured to:
create alternative script that comprises the remote maintenance operation, the at least one flagged device and a future time to perform the remote maintenance operation.

11. The apparatus of claim 10, wherein the processor is further configured to:
identify at least one maintenance restriction of the at least one flagged device; and
apply the at least one maintenance restriction to the alternative script to create the future time to perform the remote maintenance operation.

12. The apparatus of claim 11, wherein the remote maintenance operation comprises at least one of a software application update, a hard disk scan, memory allocation, and a computer virus scan.

13. The apparatus of claim 12, wherein the processor is further configured to check the at least one flagged device periodically to determine whether a maintenance restriction has been removed, and if so, then perform the maintenance operation on the at least one flagged device.

14. The apparatus of claim 13, wherein the at least one restriction is identified by a flag associated with the at least one flagged device and the removal of the restriction comprises the flag being removed.

15. A non-transitory computer readable storage medium configured to store instructions that when executed cause a processor to perform:
accessing an agent portal via an administrator machine operating on a network;
receiving an application user interface;
requesting a device list of active network devices currently operating on the network;
receiving the device list from memory;
identifying a plurality of devices requiring a remote maintenance operation and at least one flagged device which requires an alternative type of remote maintenance; and
performing the remote maintenance operation on at least one of the plurality of devices.

16. The non-transitory computer readable storage medium of claim 15, wherein the processor is further configured to perform:
creating a script that automatically performs the remote maintenance operation on the plurality of devices; and
removing the least one flagged device from the script.

17. The non-transitory computer readable storage medium of claim 16, wherein the processor is further configured to perform:
creating alternative script that comprises the remote maintenance operation, the at least one flagged device and a future time to perform the remote maintenance operation.

18. The non-transitory computer readable storage medium of claim 16, wherein the processor is further configured to perform:
identifying at least one maintenance restriction of the at least one flagged device; and
applying the at least one maintenance restriction to the alternative script to create the future time to perform the remote maintenance operation.

19. The non-transitory computer readable storage medium of claim 18, wherein the remote maintenance operation comprises at least one of a software application update, a hard disk scan, memory allocation, and a computer virus scan.

20. The non-transitory computer readable storage medium of claim 19, wherein the processor is further configured to perform:
checking the at least one flagged device periodically to determine whether a maintenance restriction has been removed; and
if so, then performing the maintenance operation on the at least one flagged device, and wherein the at least one restriction is identified by a flag associated with the at least one flagged device and the removal of the restriction comprises the flag being removed.
